(19) United States
(12) Patent Application Publication
(10) Pub. No.: US 2024/0053666 A1
(43) Pub. Date: Feb. 15, 2024

(54) FOLDABLE PROJECTOR FOR DISPLAY DEVICE

(71) Applicant: Joseph MONTAVON, Akron, OH (US)

(72) Inventor: Joseph MONTAVON, Akron, OH (US)

(21) Appl. No.: 17/818,565

(22) Filed: Aug. 9, 2022

(51) Int. Cl. G03B 21/58; G03B 21/60

(52) U.S. Cl. CPC G03B 21/58; G03B 21/60

(57) ABSTRACT

This disclosure is of a projection device comprising a reflective portion and an aperture portion comprising an aperture. The projection device may be connected to a display device such as a mobile phone. The projection device may be assembled and disassembled while connected to a display device.

### I. BACKGROUND

The present teaching pertains to the art of projection. More specifically, to the art of projecting an image from an electronic device.

Most ways to project images from an electronic device include using an electronic projector. However, there are many shortcomings to electronic projectors.

### II. SUMMARY

In accordance with one aspect of the present teaching, a projection device includes an aperture portion comprising an aperture and a reflective portion.

In accordance with a further aspect of the present teaching, a projection device further includes a first side flap connected to the aperture portion, a front shield connected to the aperture portion, a second side flap connected to the front shield portion, and a back shield connected to the second side flap.

In accordance with a further aspect of the present teaching, a method of assembling a projection device into a projection arrangement includes providing a projection device comprising an aperture portion, a reflective portion, a first side flap, a front shield, a second side flap, and a back shield and wherein the front shield is connected to the aperture portion; placing the first end of the reflective portion on the display or past the distal side of the display device, folding a first side flap so that it touches the second end of the reflective portion, folding the second side flap so that it touches the front shield, and folding the back shield so that it touches the backside of reflective portion.

Still other benefits and advantages of the present teaching will become apparent to those skilled in the art.

### III. BRIEF DESCRIPTION OF THE FIGURES

The present teaching may take physical form in certain parts and arrangement of parts, aspects of which will be described in detail in this specification and illustrated in the accompanying drawings which form a part hereof and wherein:

FIG. 1 is a top-down view of the projection device 16 assembled and attached to display device 8;

FIG. 2 is a backside view of projection device 16 partially assembled and attached to display device 8;

FIG. 3 is a backside view of projection device 16 assembled and sitting on display 10 of display device 8;

FIG. 4 is a top-down view of projection device 16 assembled and sitting on display 10 of display device 8;

FIG. 5 is a diagram showing front projection and back projection; and

FIG. 6 is a top-down view of projection device 16 assembled in the compact arrangement and sitting on backside 9 of display device 8.

### IV. DETAILED DESCRIPTION

Referring now to the Figures, the showings are for purposes of illustrating aspects of the disclosure only and not for purposes of limiting the same, and wherein like reference numerals are understood to refer to like components.

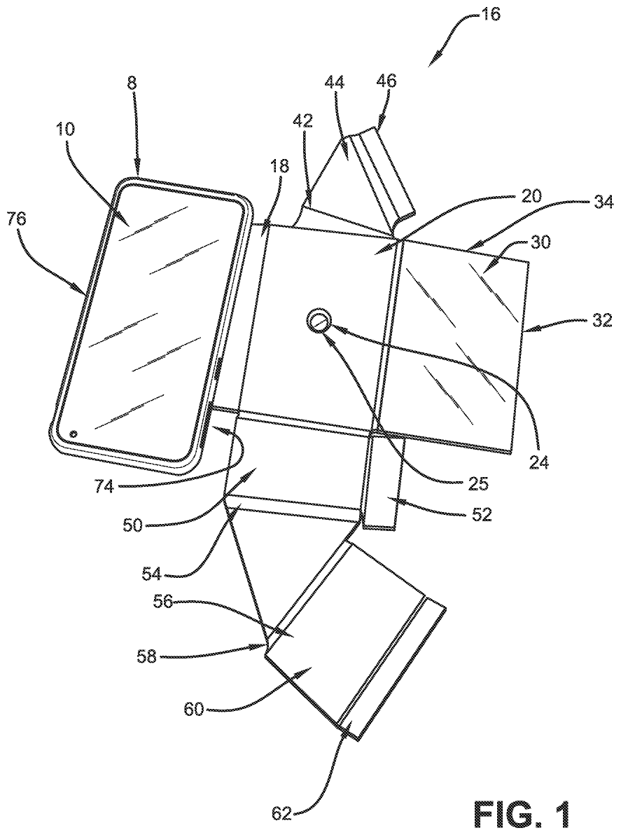

With reference to FIG. 1, shown are display device 8 and projection device 16. Display device 8 may be any type of electronic device with a display for displaying images. Display device 8 may be a mobile phone, a handheld electronic device such as an iPad or Nintendo Switch gaming device, or any other type of device with a display.

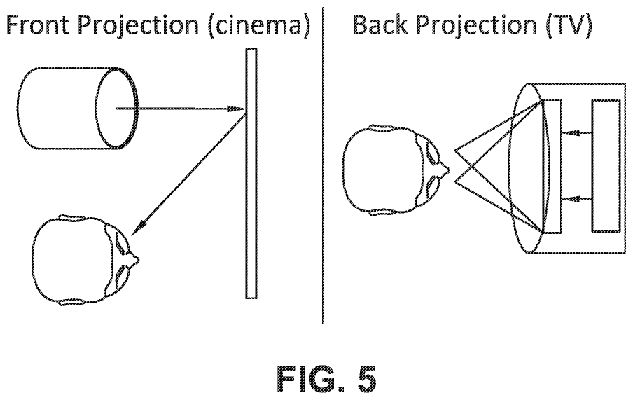

Display device 8 includes display 10. Display 10 may display an image through the use of back projection. The present teaching distinguishes between back projection and front projection, shown in FIG. 5. As shown in FIG. 5, front projection is where a device projects an image onto a screen and a user views the reflection of the image off the screen. An example of this is a movie projector used with a movie screen. In contrast, back projection is when the image is created behind the display and the viewer views the display while using the device. An example of this is a liquid crystal display. For the purpose of this disclosure, the following are considered back-projection means for generating an image: light-emitting diode displays, organic light-emitting diode displays, and any similar technology.

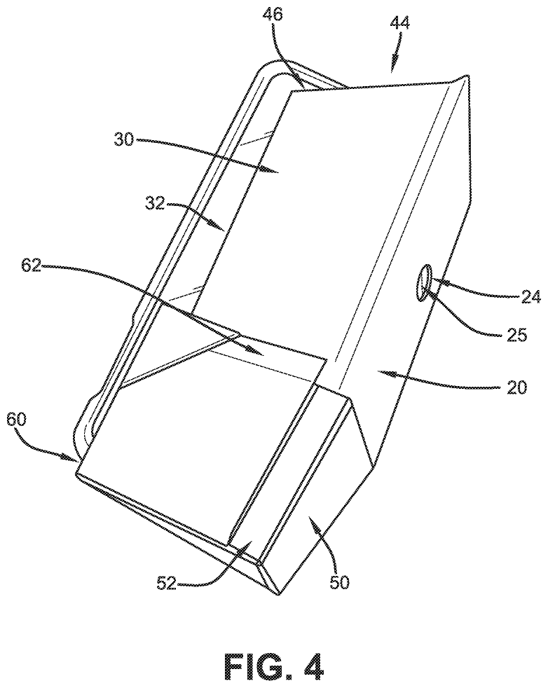

The present teaching provides a means for projecting the image that is displayed on devices that use back projection. For example, as shown in FIG. 4, when projection device 16 is assembled in the projection arrangement a user can place projection device 16 on top of a smartphone and project the image created by the smartphone display onto a wall. This will become apparent from the following disclosure.

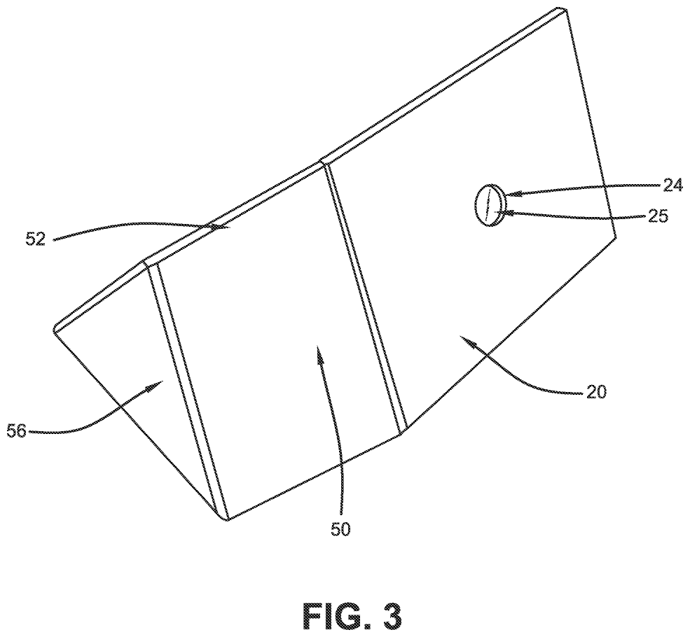

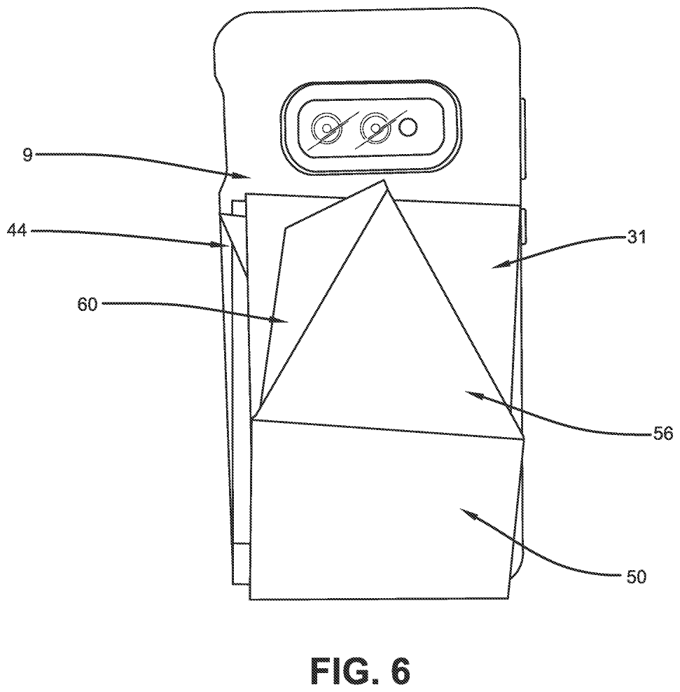

FIG. 1 shows projection device 16 unassembled, FIGS. 3 and 4 show it assembled in the projection arrangement, and FIG. 6 shows projection device 16 in the compact arrangement.

With reference to FIG. 1, projection device 16 has member 18. In one or more aspects, member 18 is configured to sit along the side of device 8 or close to the side of device 8 when projection device 16 is assembled in the projection arrangement. Adjacent to member 18 is aperture portion 20. Aperture portion 20 has aperture 24. Aperture 24 is the aperture 24 from which the image exits when projection device 16 is projecting. In one or more aspects, aperture 24 has a lens 25. Adjacent to aperture portion 20 is reflective portion 30. Reflective portion 30 may be made of any suitable reflective surface such that light hits it and is reflected. In one or more aspects, reflective portion 30 is substantially flat. In one or more aspects, reflective portion 30 is positioned at an acute angle to display 10. This way, the image is reflected out of aperture 24. In one or more aspects, reflective portion 30 has first end of reflective portion 32 and second end of reflective portion 34.

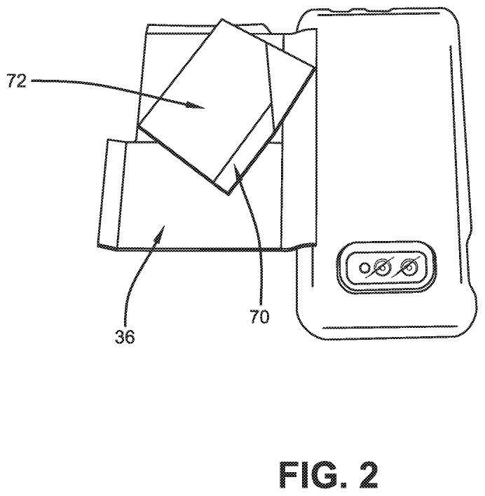

With reference to FIG. 2, in one or more aspects member 18, aperture portion 20, and reflective portion 30 are attached to backing membrane 36. Backing membrane 36 may be attached to device 8 by a pressure-sensitive adhesive tape or a magnet. This construction allows for member 18, aperture portion 20, and reflective portion 30 to be close to each other and allows projection device 16 to be folded. Backing membrane 36 may be flexible so that projection device 16 can fold. In one or more aspects, backing membrane 36 is attached to a device protector that covers display device 8. It is understood by a person of ordinary skill that projection device 16 will function the same and can be adapted to attach to device protectors.

In one or more aspects, projection device 16 does not have backing membrane 36 to which portions are attached. Instead, aperture portion 20 and reflective portion 30 may be a single piece. In one or more aspects, aperture portion 20 and reflective portion 30 may be more than one piece, but they are connected. One discovery in this disclosure is that the arrangement of aperture portion 20 and reflective portion 30 can create an efficient and simple projection of an image from the display of any electronic device.

With continuing reference to FIG. 1, aperture portion 20 may be connected to first flexible piece 42. First flexible piece 42 may be pressure-sensitive adhesive tape or some other flexible material that is adhered to the pieces it connects. First flexible piece 42 may serve as a joint between aperture member 20 and first side flap 44.

First flexible piece 42 may be connected to first side flap 44. First side flap 44 may be designed to cover the side of the projector device 16 when projector device 16 is assembled in the projection arrangement.

First side flap 44 may have first side flap end 46. First side flap end 46 may have a magnet or other material for attaching to backing membrane 36 when projector device 16 is assembled in the projection arrangement. First side flap end 46 may be flexible so that, for example, the magnet on first side flap end 46 can fold around the side of backing membrane 36 and sit alongside it. The attachment means, such as a magnet, will keep first side flap end 46 positioned on backing membrane 36 and hold projector 16 in the projection arrangement position as shown in FIG. 4.

With continuing reference to FIGS. 1, 3, and 4, front shield 50 may be positioned adjacent to aperture portion 20. Front shield 50 may be attached to backing membrane 36 with glue or other adhesive means. In one or more aspects, when projector device 16 is assembled in the projection arrangement, front shield 50 prevents light from escaping projector device 16, as shown in FIGS. 3 and 4. In one or more aspects, front shield 50 is connected to aperture portion 20 by a pressure-sensitive adhesive tape or another means of attachment. In one or more aspects, front shield 50 is a single piece with aperture portion 20.

In one or more aspects, front shield 50 is attached to top flap 52. In one or more aspects, top flap 52 may cover the top of projector device 16 assembled in the projection arrangement, as shown in FIGS. 3 and 4.

Front shield 50 may be attached to second flexible piece 54. Second flexible piece 54 may be pressure-sensitive adhesive tape or some other flexible material that is adhered to the pieces it connects. Second flexible piece 54 may serve as a joint between front shield 50 and second side flap 56.

In one or more aspects, second side flap 56 is designed to cover the side of the projector device 16 when projector device 16 is assembled in the projection arrangement, as shown in FIG. 3.

Second side flap 56 may be connected to third flexible piece 58. Third flexible piece 58 may be pressure-sensitive adhesive tape or some other flexible material that is adhered to the pieces it connects. Third flexible piece 58 may serve as a joint between second side flap 56 and back shield 60.

Back shield 60 may be attached to third flexible piece 58. In one or more aspects, when projector device 16 is assembled in the projection arrangement, back shield 60 prevents light from escaping projector device 16, as shown in FIG. 4. In one or more aspects, when projector device 16 is assembled in the projection arrangement top flap 52 is positioned underneath back shield 60, as shown in FIG. 4. This solves the problem of sealing the crack between front shield 50 and back shield 60 where light could enter.

Back shield 60 may have back shield end 62. Back shield end 62 may have a magnet or other material for attaching to backing membrane 36 when projector device 16 is assembled in the projection arrangement. In one or more aspects, there is a fold line 64 going through back shield 60 and back shield end 62, as shown in FIG. 1. Back shield 60 may be reflective so as to reflect image 80.

With continuing reference to FIG. 2, in one or more aspects backing membrane 36, front shield 50, or back shield 60 may have one or more slit 70. In one or more aspects, one or more slit 70 is located on the side that comprises the outside of projection device 16. The outside side is the side visible when projection device 16 is assembled in the projection arrangement, as shown in FIG. 4. Each slit 70 corresponds and is the opening of pocket 72. Pocket 72 may be adapted to fit and retain cards such as credit cards.

The following is a method for taking unassembled projection device 16 and assembling it into the projection arrangement. The steps of the method can be done in a different order than what is described here. First, note that display device 8 has a proximal side 74 and distal side 76. Member 18 sits adjacent to proximal side 74.

Starting from the state where projection device 16 is unassembled, reflective portion 30 is lifted and the first end 32 of reflective portion 30 is placed either on display 10 or past the distal side 76 of display device 8. The purpose of placing the end of reflective portion 30 this way is to cover the amount of display 10 that a user wishes to project with projection device 16. In one or more aspects, front shield 50 is connected to aperture portion 20, so placing reflective portion 30 this way necessarily lifts front shield 50 to be in the same position as aperture portion 20, as shown in FIG. 3.

Next, a user performing the method may fold first side flap 44 or second side flap 56. If a user folds first side flap 44, the step is folding first side flap 44 to touch the second side 34 of reflective portion 30. In one or more aspects, the method also includes folding first side flap end 46 to touch reflective portion 30.

The step of folding second side flap 56 includes folding second side flap 56 inward so that front shield 50 and second side flap 56 create a corner. In one or more aspects, this corner contains second flexible piece 54.

Next back shield 60 may be folded. The step of folding back shield 60 includes folding it so that it contacts reflective portion 30. In one or more aspects, after back shield 60 is folded, top flap 52 may be manipulated and positioned underneath back shield 60, as shown in FIG. 4. It should be understood that these steps may be done in other orders. Projection device 16 is shown in FIGS. 3 and 4 in the projection arrangement. In one or more aspects, the disassembly process is the same as the assembly process but in reverse.

After projection device 16 is assembled in the projection arrangement, a device 8 that is projecting an image 80 will project that image 80 onto reflective portion 30. In one or more aspects, reflective portion 30 reflects image 80 through aperture 24. A person may view image 80 as it is projected by projecting the image onto a surface such as a wall.

Note that projection device 16 can still project despite not all portions of projection device 16 being folded into the projection arrangement shown in FIGS. 3 and 4. For example, in one or more aspects projection device 16 may be mostly assembled but back shield 60 is not folded down to contact reflective portion 30. This arrangement is different than the projection arrangement shown in FIGS. 3 and 4, but projection device 16 will still project nonetheless. In this teaching, projection arrangement may refer to any assembly of projection device 16 where projection device 16 can reflect an image 80 from reflective portion 30. In a preferred aspect of this teaching, this includes assembling aperture portion 20, reflective portion 30, front shield 50, and back shield 60 to be oriented in the same plane as shown in FIGS. 3 and 4.

In one or more aspects, the projection device 16 can be assembled into a compact arrangement. For example, in one or more aspects projection device 16 in the compact arrangement can fit inside a pant pocket while it is attached to a display device such as a mobile phone.

The following is a method for taking unassembled projection device 16 and assembling it into the compact arrangement. The steps of the method can be done in a different order than what is described here. Referring to FIGS. 1 and 6, first, fold first side flap 44 onto aperture portion 20. Next, fold reflective portion 30 onto first side flap 44. The parts are now arranged as follows: aperture portion 20 on bottom, first side flap 44 in the middle, and reflective portion 30 on top. This is referred to as the aperture-reflective assembly 82. Next, aperture-reflective assembly 82 is folded onto back side 9 of the display device 8. Next, front shield 50 is folded onto the back side 31 of reflective portion 30. At this point, second side flap 56 may cover a portion of back side 31 of reflective portion 30. This is shown in FIG. 6. Then, back shield 60 is folded so that it sits underneath second side flap 56 and touches back side 31 of reflective portion 30. This fold may be along a split between second side flap 56 and back shield 60 that is covered by third flexible piece 58.

In one or more aspects, projection device 16 may be repeatedly rearranged from unassembled, assembled into the projection arrangement, and assembled into the compact arrangement. In one or more aspects, this assembly is done only through folding and unfolding parts of projection device 16. Further, in one or more aspects, projection device 16 can be arranged into any of these arrangements from any of the other arrangements.

Numerous aspects have been described, hereinabove. It will be apparent to those skilled in the art that the above methods and devices may incorporate changes and modifications without departing from the general scope of the present teaching. It is intended to include all such modifications and alterations in so far as they come within the scope of the appended claims or the equivalents thereof.

Having thus described the present teaching, it is now claimed:

I/We claim:

1. A projection device comprising:
a. an aperture portion comprising an aperture; and
b. a reflective portion.

2. The device of claim 1, wherein the aperture portion and the reflective portion are both substantially flat.

3. The device of claim 1, wherein when the projection device is arranged to project an image from an associated electronic device, the reflective portion is positioned above the associated electronic device and at an acute angle to a display of the associated electronic device.

4. The device of claim 1, wherein the projection device is configured to be attached to an associated display device.

5. The device of claim 1, wherein when the projection device is connected to the associated display device it can be assembled and disassembled solely by folding and unfolding it.

6. The device of claim 1, further comprising a first side flap connected to the aperture portion, a front shield connected to the aperture portion, a second side flap connected to the front shield portion, and a back shield connected to the second side flap.

7. The device of claim 1, wherein connected to the front shield is a top flap.

8. The device of claim 7, wherein the first side flap further comprises a first side flap end comprising a magnet and wherein the back shield further comprises a back shield end comprising a magnet.

9. The device of claim 8, wherein the first side flap end is substantially flexible and when the projection device is assembled in the projection arrangement the magnet is magnetically attracted to the reflective portion.

10. The device of claim 1, wherein the back shield has a slit and a pocket.

11. The device of claim 1, wherein the device does not have any electronic components.

12. A method of assembling a projection device into a projection arrangement comprising:
a. providing a projection device comprising an aperture portion, a reflective portion, a first side flap, a front shield, a second side flap, and a back shield and wherein the front shield is connected to the aperture portion;
b. placing the first end of the reflective portion on the display or past the distal side of the display device;
c. folding the first side flap so that it touches the second end of the reflective portion;
d. folding a second side flap so that it touches the front shield; and
e. folding the back shield so that it touches the backside of the reflective portion.

13. The method of claim 12, wherein the first side flap has a first side flap end comprising a magnet and the method further comprises folding the first flap end to touch the back of the reflective portion and stay magnetically affixed to it.

14. The method of claim 12, wherein the back shield has a back shield end comprising a magnet and the method further comprises folding the back shield to touch the back of the reflective portion and stay magnetically affixed to it.

15. The method of claim 13, wherein the front shield is connected to a top flap and the method further comprises positioning the top flap underneath the back shield.

16. A method of assembling a projection device into a compact arrangement comprising:
a. providing a projection device comprising an aperture portion, a reflective portion, a first side flap, a front shield, a second side flap, and a back shield and wherein the front shield is connected to the aperture portion;
b. folding the first flap onto an aperture portion;
c. folding the reflective portion onto the first side flap;
d. folding a front shield onto a back side of the reflective portion wherein the front shield is connected to a second side flap; and
e. folding a back shield under a second side flap.
